(19) United States
(12) Patent Application Publication
(10) Pub. No.: US 2023/0419451 A1
(43) Pub. Date: Dec. 28, 2023

(54) IMAGE PROCESSING METHOD, IMAGE PROCESSING APPARATUS, AND RECORDING MEDIUM

(71) Applicant: Topcon Corporation, Tokyo (JP)

(72) Inventor: Shinnosuke AZUMA, Tokyo (JP)

(73) Assignee: Topcon Corporation, Tokyo (JP)

(21) Appl. No.: 18/212,212

(22) Filed: Jun. 21, 2023

(30) Foreign Application Priority Data
Jun. 23, 2022 (JP) 2022-100776

(51) Int. Cl. G06T 5/00

(52) U.S. Cl. CPC G06T 5/002; G06T 2207/10101; G06T 2207/20216; G06T 2207/20081

(57) ABSTRACT

An embodiment is a method of processing an optical coherence tomography (OCT) image. The method is configured to acquire a plurality of images by applying a plurality of OCT scans corresponding to a plurality of different polarization conditions to a sample, and then generate a mean image with a reduced birefringence-derived artifact by applying averaging to the plurality of images corresponding to the plurality of different polarization conditions.

### CROSS-REFERENCE TO RELATED APPLICATION

This application is based upon and claims the benefit of priority from Japanese Patent Application No. 2022-100776, filed Jun. 23, 2022; the entire contents of which are incorporated herein by reference.

### TECHNICAL FIELD

The present disclosure generally relates to a method, an apparatus, and a recording medium for processing optical coherence tomography (OCT) images.

### BACKGROUND OF THE INVENTION

In recent years, OCT has been attracting attention for generating images representing the surface and internal morphology of an object (sample) to be measured using a light beam from a laser light source or like light sources. Since OCT is not invasive to the living body like X-ray computed tomography (CT), OCT is expected to develop applications in the fields of medicine and biology in particular. For example, in the field of ophthalmology, apparatuses and devices for generating images of the eye fundus, cornea, and so forth have been put to practical use.

Various artifacts occur in OCT images. One of these artifacts is derived from the birefringence property of the sample. Birefringence is an optical property of a material that has a refractive index depending on the polarization and propagation direction of light. A ray of light passing through a birefringent sample is split into two rays depending on its state of polarization. Artifacts derived from birefringence (hereinafter referred to as birefringence-derived artifacts) occur not only in OCT images generated by OCT modalities that can detect polarization, but also in general OCT intensity images. OCT modalities having the function of detecting polarization (generally referred to as polarization-sensitive OCT) are disclosed by, for example, Japanese Patent No. 4344829, Japanese Patent No. 6256879, and Japanese Patent No. 6579718.

One of the known techniques for removing birefringence-derived artifacts is implemented by separating an OCT signal into two polarization components and detecting the two polarization components, and then combining the intensities of the two polarization component signals detected and generating an OCT intensity signal. This technique is implemented using a detection module (hereinafter referred to as polarization separation detection function) that is a combination of a polarizing beam splitter (polarization beam splitter) and two optical detectors, which is described, for example, in the following document: Shuichi Makita, Toshihiro Mino, Tastuo Yamaguchi, Mashiro Miura, Shinnosuke Azuma, and Yoshiaki Yasuno, “Clinical prototype of pigment and flow imaging optical coherence tomography for posterior eye investigation”, Biomedical Optics Express, Vol. 9, Issue 9, pp. 4372-4389 (2018).

### BRIEF SUMMARY OF THE INVENTION

A purpose of the present disclosure is to provide a novel technique of generating images with reduced birefringence-derived artifacts from images acquired by OCT modalities without polarization separation detection function.

An aspect of the embodiments is a method of processing an optical coherence tomography (OCT) image. The method includes: acquiring a plurality of images by applying a plurality of OCT scans corresponding to a plurality of different polarization conditions to a sample; and generating a mean image with a reduced birefringence-derived artifact by applying averaging to the plurality of images corresponding to the plurality of different polarization conditions.

Another aspect of the embodiments is an apparatus of processing an optical coherence tomography (OCT) image. The apparatus includes an image acquiring unit and a processor. The image acquiring unit is configured to acquire a plurality of images generated by applying a plurality of OCT scans corresponding to a plurality of different polarization conditions to a sample. The processor is configured to generate a mean image with a reduced birefringence-derived artifact by applying averaging to the plurality of images corresponding to the plurality of different polarization conditions.

Another aspect of the embodiments is a computer-readable non-transitory recording medium in which a program for processing an optical coherence tomography (OCT) image is recorded. The program is configured to cause a computer to perform: a step of acquiring a plurality of images generated by applying a plurality of OCT scans corresponding to a plurality of different polarization conditions to a sample; and a step of generating a mean image with a reduced birefringence-derived artifact by applying averaging to the plurality of images corresponding to the plurality of different polarization conditions.

### BRIEF DESCRIPTION OF THE SEVERAL VIEWS OF THE DRAWING

FIG. 1 is a diagram illustrating an example of a configuration of an image processing apparatus (ophthalmic apparatus) according to an aspect example of an embodiment.

FIG. 2 is a diagram illustrating an example of a configuration of an image processing apparatus (ophthalmic apparatus) according to an aspect example of an embodiment.

FIG. 3 is a diagram illustrating an example of a configuration of an image processing apparatus (ophthalmic apparatus) according to an aspect example of an embodiment.

FIG. 4 is a diagram illustrating an example of a configuration of an image processing apparatus (ophthalmic apparatus) according to an aspect example of an embodiment.

FIG. 5 is a diagram for describing an example of a way of using an image generated by an image processing apparatus (ophthalmic apparatus) according to an aspect example of an embodiment.

FIG. 6 is a diagram for describing an example of a way of using an image generated by an image processing apparatus (ophthalmic apparatus) according to an aspect example of an embodiment.

FIG. 7A is a diagram for describing an example of a way of using an image generated by an image processing apparatus (ophthalmic apparatus) according to an aspect example of an embodiment.

FIG. 7B is a diagram for describing an example of a way of using an image generated by an image processing apparatus (ophthalmic apparatus) according to an aspect example of an embodiment.

FIG. 8 is a diagram for describing an example of a way of using an image generated by an image processing apparatus (ophthalmic apparatus) according to an aspect example of an embodiment.

FIG. 9 is a flowchart illustrating an example of an application of an image processing apparatus (ophthalmic apparatus) according to an aspect example of an embodiment.

FIG. 10 is a flowchart illustrating an example of an application of an image processing apparatus (ophthalmic apparatus) according to an aspect example of an embodiment.

FIG. 11 is a flowchart illustrating an example of an operation of an image processing apparatus (ophthalmic apparatus) according to an aspect example of an embodiment.

FIG. 12 is a flowchart illustrating an example of an operation of an image processing apparatus (ophthalmic apparatus) according to an aspect example of an embodiment.

### DETAILED DESCRIPTION OF THE INVENTION

An image processing method, an image processing apparatus, a program, and a recording medium according to some aspect examples of some embodiments will be described in detail with reference to the drawings. While the present disclosure describes some application examples in the field of ophthalmology in particular, embodiments are not limited thereto and applications may be done to any kinds of fields where OCT is available for use and where birefringence-derived artifacts do or can occur.

Any of the matters and items described in the documents cited in the present disclosure and any matters and items related to any other known techniques and technologies may be combined with any of the embodiments. In addition, the present disclosure does not distinguish “image data” and an “image” that is visualized information based on this image data from each other unless otherwise mentioned.

An image processing apparatus according to some embodiments has the function of acquiring an OCT image of a sample. Any configuration may be employed to implement this function. In some aspect examples, the image processing apparatus is configured to collect data by applying an OCT scan to a sample and construct an OCT image by processing the collected data to obtain an OCT image of the sample. The type of OCT (the type of the OCT modality) used for this OCT scan may be freely selected, and may be, for example, Fourier domain OCT (swept source OCT or spectral domain OCT) or time domain OCT.

Further, in some aspect examples, the image processing apparatus is configured to acquire an OCT image of a sample from the outside. The image processing apparatus configured in this way may include, for example, any of the following devices: a communication device configured for receiving an OCT image stored in a storage device via a communication line; a communication device configured for receiving an OCT image acquired by an OCT apparatus via a communication line; and a data reader configured for reading out an OCT image recorded on a recording medium.

An image processing apparatus according to some embodiments is configured to acquire a plurality of images by applying a plurality of OCT scans respectively corresponding to a plurality of different polarization conditions (polarization states) to a sample. More specifically, an image processing apparatus according to some embodiments is configured to acquire a plurality of images by applying a plurality of OCT scans respectively corresponding to a plurality of different polarization conditions to a sample using an OCT scanner of the image processing apparatus and/or is configured to acquire a plurality of images by applying a plurality of OCT scans respectively corresponding to a plurality of different polarization conditions to a sample using an external OCT apparatus. The plurality of polarization conditions is generated, for example, by using a polarization modulator(s) provided in either one of or both the measurement arm (sample arm) and the reference arm of the OCT scanner.

Furthermore, the image processing apparatus according to some embodiments has the function of generating an image with a reduced birefringence-derived artifact (that is, an image in which a birefingence-derived artifact has been reduced) from the plurality of images acquired. More specifically, the image processing apparatus according to some embodiments generates the image with the reduced birefringence-derived artifact by applying averaging (averaging processing, image averaging) to the plurality of images respectively corresponding to the plurality of polarization conditions. The image generated in this way is referred to as a mean image (or average image, averaged image, etc.).

The mean image generated by the image processing apparatus according to some embodiments is stored and/or provided (transmitted), for example. In some aspect examples, the mean image is stored in a storage device located inside or outside the image processing apparatus. The storage device inside the image processing apparatus may be, for example, a hard disk drive, a solid state drive, or the like. The storage device external to the image processing apparatus may be, for example, a database system, a data management system, or the like. An example of such a system is a picture archiving and communication system (PACS), which is a typical image management system in the medical field.

Further, in some aspect examples, the mean image generated by the image processing apparatus is provided to a computer located inside or outside the image processing apparatus. This computer has the function of processing the mean image to generate new information. Examples of this function of the computer include the following functions: the function of analyzing the mean image to generate analysis information; the function of processing the mean image to generate a visualization (visualization information); the function of combining the mean image and other information to generate new information; the function of generating training data (learning data) for machine learning based on the mean image; the function of performing machine learning using training data that includes the mean image and/or training data that includes information generated based on the mean image; the function of performing inference processing using the mean image and/or information generated based on the mean image; and a function implemented by combining two or more of these functions at least in part.

At least one or more of the functions of the elements according to the present disclosure are implemented by using a circuit configuration (or circuitry) or a processing circuit configuration (or processing circuitry). The circuitry or the processing circuitry includes any of the followings, all of which are configured and/or programmed to execute at least one or more functions disclosed herein: a general purpose processor, a dedicated processor, an integrated circuit, a central processing unit (CPU), a graphics processing unit (GPU), an application specific integrated circuit (ASIC), a programmable logic device (e.g., a simple programmable logic device (SPLD), a complex programmable logic device (CPLD), or a field programmable gate array (FPGA)), a conventional circuit configuration or circuitry, and any combination of these. A processor is considered to be processing circuitry or circuitry that includes a transistor and/or another circuitry. In the present disclosure, circuitry, a unit, a means, or a term similar to these is hardware that executes at least one or more functions disclosed herein, or hardware that is programmed to execute at least one or more functions disclosed herein. Hardware may be the hardware disclosed herein, or alternatively, known hardware that is programmed and/or configured to execute at least one or more functions described in the present disclosure. In the case where the hardware is a processor, which may be considered as a certain type of circuitry, then circuitry, a unit, a means, or a term similar to these is a combination of hardware and software. In this case, the software is used to configure the hardware and/or the processor.

### <Configuration of Image Processing Apparatus (Ophthalmic Apparatus)>

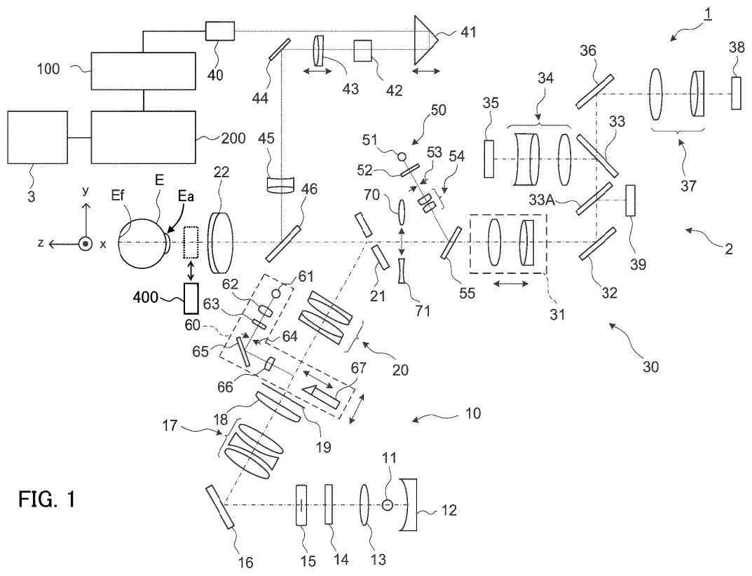

The ophthalmic apparatus 1 shown in FIG. 1 is one aspect example of an image processing apparatus according to some embodiments. In order to acquire an OCT image of a sample, the ophthalmic apparatus 1 is configured to collect data by applying an OCT scan to the sample and construct an OCT image by processing the data collected. The sample of the present aspect example is a living eye of a human subject (hereinafter referred to as a subject's eye).

The ophthalmic apparatus 1 is a multifunction apparatus that is a combination of an OCT apparatus and a fundus camera. The ophthalmic apparatus 1 has both the function of applying OCT scanning to the subject's eye E (the eye fundus Ef and the anterior eye segment Ea) and the function of conducting digital photography of the subject's eye E (the eye fundus Ef and the anterior eye segment Ea).

The ophthalmic apparatus 1 includes the fundus camera unit 2, the OCT unit 100, and the arithmetic and control unit 200. The fundus camera unit 2 is provided with an element group (e.g., optical systems, mechanisms, etc.) for performing acquisition of a front image of a subject's eye. The OCT unit 100 includes part of an element group (e.g., optical systems, mechanisms, etc.) for performing OCT scanning. Some other parts or elements of the element group for OCT scanning are provided in the fundus camera unit 2. The arithmetic and control unit 200 includes one or more processors configured and programmed to execute various kinds of processing (e.g., calculations, controls, etc.), and one or more storage devices (memories). Further, the ophthalmic apparatus 1 also include a chin rest, a forehead rest, and other parts.

The attachment 400 includes a lens group used for switching sites of the subject's eye E to which OCT scanning is applied between the posterior segment (the eye fundus Ef) and the anterior eye segment Ea. The attachment 400 may be, for example, the optical unit disclosed in Japanese Unexamined Patent Application Publication No. 2015-160103. The attachment 400 is inserted into a position between the objective lens 22 and the subject's eye E. The attachment 400 is removed from the optical path when applying OCT scanning to the eye fundus Ef, and the attachment 400 is placed in the optical path when applying OCT scanning to the anterior eye segment Ea. Conversely, the configuration may be employed in which the attachment 400 is removed from the optical path when applying OCT scanning to the anterior eye segment Ea, and the attachment 400 is placed in the optical path when applying OCT scanning to the eye fundus Ef. The movement (insertion and removal) of the attachment 400 is performed by hand or by machine (manually or automatically). An element configured to switch sites of a subject's eye to which OCT scanning is applied, is not limited to the above or like attachments, and may have, for example, a configuration that includes one or more lenses movable along an optical path.

### <Fundus Camera Unit 2>

The fundus camera unit 2 includes elements (e.g., optical elements, mechanisms, etc.) for performing digital photography of the subject's eye E. The digital images acquired are front images (en face images) such as observation images and photographed images. An observation image is obtained, for example, by capturing a moving image using near-infrared light, and may be used for alignment, focusing, tracking, and other operations. A photographed image is a still image obtained using visible flash light or infrared flash light, for example. A photographed image may be used for medical diagnosis, analysis, or other purposes.

The fundus camera unit 2 includes the illumination optical system 10 and the photographing optical system 30. The illumination optical system 10 projects illumination light onto the subjects eye E. The photographing optical system 30 detects return light of the illumination light from the subject's eye E. Measurement light entered from the OCT unit 100 is directed to the subjects eye E through an optical path in the fundus camera unit 2, and return light of this measurement light from the subjects eye E is directed to the OCT unit 100 through the same optical path.

Light emitted by the observation light source 11 of the illumination optical system 10 (referred to as observation illumination light) is reflected by the concave mirror 12, passes through the condenser lens 13, and becomes near-infrared light after passing through the visible cut filter 14. Further, the observation illumination light is once converged at a location near the photographing light source 15, reflected by the mirror 16, and passes through the relay lens system 17, the relay lens 18, the diaphragm 19, and the relay lens system 20. Then, the observation illumination light is reflected on the peripheral part (i.e., the area surrounding the aperture part) of the aperture mirror 21, penetrates the dichroic mirror 46, and refracted by the objective lens 22 (and the optical elements in the attachment 400), thereby illuminating the subjects eye E. Return light of the observation illumination light from the subjects eye E is refracted by (the optical elements in the attachment 400 and) the objective lens 22, penetrates the dichroic mirror 46, passes through the aperture part formed in the center area of the aperture mirror 21, passes through the dichroic mirror 55, travels through the photography focusing lens 31, and is reflected by the mirror 32. Furthermore, the return light of the observation illumination light passes through the half mirror 33A, is reflected by the dichroic mirror 33, and forms an image on the light receiving surface of the image sensor 35 by the imaging lens 34. The image sensor 35 detects the return light at a predetermined frame rate. Typically, the photographing optical system 30 is adjusted to be focused on the eye fundus Ef or the anterior eye segment Ea.

Light emitted by the photographing light source 15 (referred to as photographing illumination light) passes through the same route as the route of the observation illumination light and is projected onto the subject's eye E. Return light of the photographing illumination light from the subject's eye E passes through the same route as the route of the return light of the observation illumination light to the dichroic mirror 33, passes through the dichroic mirror 33, is reflected by the mirror 36, and forms an image on the light receiving surface of the image sensor 38 by the imaging lens 37.

The liquid crystal display (LCD) 39 displays a fixation target (fixation target image). Part of a light beam output from the LCD 39 is reflected by the half mirror 33A and the mirror 32, travels through the photography focusing lens 31 and the dichroic mirror 55, and passes through the aperture part of the aperture mirror 21. The light beam having passed through the aperture part of the aperture mirror 21 penetrates the dichroic mirror 46, and is refracted by the objective lens 22, thereby being projected onto the eye fundus Ef. Varying the display position of the fixation target image can be used to change fixation position (also referred to as fixation direction) of the subject's eye E by the fixation target. Changing the fixation position allows the line of sight of the subject's eye E to be guided in a desired direction.

The alignment optical system 50 generates an alignment indicator used for alignment of the optical system with respect to the subject's eye E. Alignment light emitted by the light emitting diode (LED) 51 travels through the diaphragm 52, the diaphragm 53, and the relay lens 54, is reflected by the dichroic mirror 55, passes through the aperture part of the aperture mirror 21, penetrates the dichroic mirror 46, and is projected onto the subjects eye E via the objective lens 22. Return light of the alignment light from the subjects eye E passes through the same route as the route of the return light of the observation illumination light and is guided to the image sensor 35. An image detected by the image sensor 35 (alignment indicator image) is used for performing manual alignment and/or automatic alignment.

The methods and techniques of the alignment are not limited to those using an alignment indicator. For example, an ophthalmic apparatus according to some aspect examples may be configured to perform the following processes, as described in Japanese Unexamined Patent Application Publication No. 2013-248376: a process of acquiring two or more anterior eye segment images of a subject's eye by conducting two or more operations of anterior eye segment photography of the anterior eye segment from two or more different directions; a process of calculating a three dimensional position of the subject's eye by analyzing the two or more anterior eye segment images; and a process of moving an optical system based on the three dimensional position calculated. This alignment technique is referred to as stereo alignment or the like.

The focusing optical system 60 generates a split indicator used for focus adjustment (focusing, focusing operation) with respect to the subject's eye E. The focusing optical system 60 is moved along the optical path of the illumination optical system 10 in conjunction with movement of the photography focusing lens 31 along the optical path of the photographing optical system 30. The optical path of the illumination optical system 10 is referred to as the illumination optical path, and the optical path of the photographing optical system 30 is referred to as the photographing optical path. The reflection rod 67 is inserted into the illumination optical path and placed in an oblique orientation in order to perform focus adjustment. Focus light emitted by the LED 61 passes through the relay lens 62, is split into two light beams by the split indicator plate 63, and passes through the two-hole diaphragm 64. The focus light, then, is reflected by the mirror 65, is converged on the reflective surface of the reflection rod 67 by the condenser lens 66, and is reflected by the reflective surface. Further, the focus light travels through the relay lens 20, is reflected by the aperture mirror 21, and penetrates the dichroic mirror 46, thereby being projected onto the subject's eye E via the objective lens 22. Return light of the focus light from the subject's eye E passes through the same route as the route of the return light of the alignment light and is guided to the image sensor 35. An image detected by the image sensor 35 (split indicator image) is used for performing manual focusing and/or automatic focusing.

The diopter correction lenses 70 and 71 are selectively inserted into the photographing optical path between the aperture mirror 21 and the dichroic mirror 55. The diopter correction lens 70 is a positive lens (convex lens) for correcting high hyperopia. The diopter correction lens 71 is a negative lens (concave lens) for correcting high myopia.

The dichroic mirror 46 couples the optical path for digital photography and the optical path for OCT scanning. The optical path for digital photography includes the illumination optical path and the photographing optical path. The optical path for OCT scanning is referred to as a sample arm. The dichroic mirror 46 reflects light of wavelength bands used for OCT scanning while transmitting light for digital photography. Listed from the OCT unit 100 side, the sample arm includes the collimator lens unit 40, the retroreflector 41, the dispersion compensation member 42, the OCT focusing lens 43, the optical scanner 44, and the relay lens 45.

The retroreflector 41 is movable in the directions indicated by the arrow in FIG. 1. These directions are the direction in which the measurement light LS is incident onto the subject's eye E and the direction in which return light of the measurement light LS from the subject's eye E travels. With this movement of the retroreflector 41, the length of the sample arm is changed. The operation of changing the sample arm length may be used for various kinds of operations such as optical path length correction on the basis of eye axial length, optical path length correction on the basis of corneal shape and/or eye fundus shape, and adjustment or regulation of interference conditions or states.

The dispersion compensation member 42, together with the dispersion compensation member 113 (described later) arranged in the reference arm, acts to equalize the dispersion characteristics of the measurement light LS and the dispersion characteristics of the reference light LR with each other.

The OCT focusing lens 43 is movable in the directions indicated by the arrow in FIG. 1 (that is, in the direction along the optical axis of the sample arm) in order to perform focus adjustment of the sample arm. With this movement of the OCT focusing lens 43, the focus conditions or the focus states (focal position, focal length) of the sample arm is changed. The ophthalmic apparatus 1 may be configured to be capable of executing interlocking control of the movement of the photography focusing lens 31, the movement of the focusing optical system 60, and the movement of the OCT focusing lens 43.

The optical scanner 44 is placed substantially at a position optically conjugate with the pupil of the subject's eye E. The optical scanner 44 is a deflector used for changing the travelling direction (propagation direction) of the measurement light LS guided by the sample arm. The optical scanner 44 of some examples may be a two dimensional deflector that includes a deflector for performing scanning in the x direction and a deflector for performing scanning in the y direction (x-scanner and y-scanner). The deflector may be of any type, and may a galvanometer scanner in some examples.

The optical scanner 44 is placed at a position substantially optically conjugate with the pupil of the subject's eye E when the attachment 400 is removed from the sample arm for posterior eye segment OCT while the optical scanner 44 is placed at a position substantially optically conjugate with a position near the anterior eye segment Ea (e.g., a position between the anterior eye segment Ea and the attachment 400) when the attachment 400 is placed in the sample arm for anterior eye segment OCT.

### <OCT Unit 100>

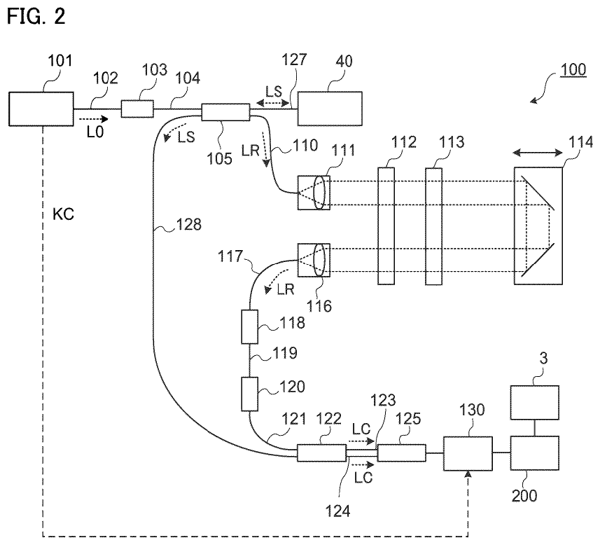

As illustrated in FIG. 2, the OCT unit 100 is provided with an optical system and mechanisms for performing swept source OCT. This optical system includes an interference optical system. This interference optical system is configured to split light emitted by a wavelength tunable light source (wavelength sweeping light source) into measurement light and reference light, to generate interference light by superposing return light of the measurement light from the subject's eye E on the reference light that has been guided by a reference optical path (reference arm), and to detect this interference light. An electrical signal (detection signal) generated by the interference light detection includes a signal (interference signal) representing a spectrum of the interference light. This detection signal is sent to the arithmetic and control unit 200 (the image data constructing unit 220).

The light source unit 101 of some examples includes a near-infrared wavelength tunable laser configured to vary the wavelengths of emitted light at high speed. The light LO output from the light source unit 101 is guided to the polarization controller 103 through the optical fiber 102. The polarization controller 103 is configured to perform regulation (adjustment) of the polarization condition of the light LO. Further, the light LO is guided to the fiber coupler 105 through the optical fiber 104. The fiber coupler 105 is configured to split the light LO into the measurement light LS and the reference light LR. The optical path of the measurement light LS is referred to as the sample arm or the like, and the optical path of the reference light LR is referred to as the reference arm or the like.

The reference light LR is guided through the optical fiber 110 to the collimator 111, is converted into a parallel light beam by the collimator 111, travels through the optical path length correction member 112 and the dispersion compensation member 113, and is guided to the retroreflector 114. The optical path length correction member 112 is an optical element for equalizing the optical path length of the reference light LR and the optical path length of the measurement light LS with each other. The dispersion compensation member 113 is an optical element for equalizing the dispersion characteristics of the reference light LR and the dispersion characteristics of the measurement light LS with each other, together with the dispersion compensation member 42 disposed in the sample arm. The retroreflector 114 is movable along the optical path of the reference light LR that is incident onto the retroreflector 114. With this, the length of the reference arm is changed. The operation of changing the reference arm length may be used for various kinds of operations such as optical path length correction on the basis of eye axial length, optical path length correction on the basis of corneal shape and/or eye fundus shape, and adjustment or regulation of interference conditions.

The reference light LR that has passed through the retroreflector 114 travels through the dispersion compensation member 113 and the optical path length correction member 112, is converted from a parallel light beam to a convergent light beam by the collimator 116, and is incident onto the optical fiber 117. The reference light LR that has entered the optical fiber 117 is guided to the polarization controller 118, and the polarization condition of the reference light LR is regulated by the polarization controller 118. The polarization controller 118 is used for optimizing the strength of interference (coherence) between the measurement light LS and the reference light LR, for example. The reference light LR output from the polarization controller 118 is guided to the attenuator 120 through the optical fiber 119, and the amount of light of the reference light LR is regulated by the attenuator 120. Subsequently, the reference light LR is guided to the fiber coupler 122 through the optical fiber 121.

Meanwhile, the measurement light LS generated by the fiber coupler 105 is guided by the optical fiber 127 to the collimator lens unit 40 and is converted to a parallel light beam by the collimator lens unit 40. The measurement light LS converted to the parallel light beam then passes through the retroreflector 41, the dispersion compensation member 42, the OCT focusing lens 43, the optical scanner 44, and the relay lens 45, the dichroic mirror 46, and the objective lens 22 (and the attachment 400), thereby being projected onto the subject's eye E. The measurement light LS incident on the subject's eye E is reflected and scattered at various depth positions of the subject's eye E. Return light (e.g., backscattered light, reflected light, etc.) of the measurement light LS from the subject's eye E travels along the same route as the outward way in the opposite direction to the fiber coupler 105, and then is guided to the fiber coupler 122 through the optical fiber 128.

The fiber coupler 122 superposes the measurement light LS (the return light from the subject's eye E) from the optical fiber 128 with the reference light LR from the optical fiber 121 to generate interference light. The fiber coupler 122 splits the generated interference light into two pieces of light at a predetermined splitting ratio (e.g., 1 to 1) to produce a pair of interference light LC. The pair of interference light LC is guided to the detector 125 through the pair of the optical fibers 123 and 124, respectively.

The detector 125 of some examples includes a balanced photo diode. This balanced photodiode includes a pair of photodetectors that detects the pair of the interference light LC respectively. The balanced photodiode outputs a difference signal between a pair of electrical signals generated by the pair of photodetectors. The difference signal (detection signal) output from the detector 125 is sent to the data acquisition system (DAQ, DAS) 130.

The clock KC is supplied from the light source unit 101 to the data acquisition system 130. The clock KC is generated in the light source unit 101 in synchronization with the output timings of individual wavelengths varied over a predetermined wavelength range by the wavelength tunable light source. The light source unit 101 of some examples is configured to split the light LO of the individual output wavelengths to generate two pieces of split light, apply an optical delay to one piece of the two pieces of split light, superpose the one piece of split light to which the optical delay is applied with the other piece of split light, detect the resulting superposed light, and generate the clock KC based on the detection result of the superposed light. Based on the clock KC input from the light source unit 101, the data acquisition system 130 performs sampling of the detection signal input from the detector 125. The result of this sampling is sent to the arithmetic and control unit 200.

The present aspect example includes both an element for changing the sample arm length (e.g., the retroreflector 41) and an element for changing the reference arm length (e.g., the retroreflector 114 or a reference mirror) while some other aspect examples may include only either one of these two elements.

The present aspect example includes the polarization controller 118 which is an example of an element for changing the polarization condition of the reference light LR. In place of the element for changing the polarization condition of the reference light LR, some aspect examples may include an element (polarization controller) for changing the polarization condition of the measurement light LS. Further, some aspect examples may include both the element for changing the polarization condition of the reference light LR and the element for changing the polarization condition of the measurement light LS.

The swept source OCT employed in the OCT unit 100 shown in FIG. 2 is a technique including the following processes: a process of splitting light emitted by a wavelength tunable light source into measurement light and reference light; a process of generating interference light by superposing return light of the measurement light from a sample and the reference light; a process of detecting the interference light by a photodetector; and a process of constructing an image of the sample by applying signal processing including a Fourier transform to detection data collected corresponding to wavelength sweeping (change in emitted wavelengths) and scanning with the measurement light. On the other hand, spectral domain OCT, which is an alternative to swept source OCT, is a technique including the following processes: a process of splitting light emitted by a low coherence light source (broad band light source, wide band light source) into measurement light and reference light; a process of generating interference light by superposing return light of the measurement light from a sample and the reference light; a process of detecting a spectral distribution (spectral components) of the interference light by a spectrometer; and a process of constructing an image of the sample by applying signal processing including a Fourier transform to the spectral distribution detected. In short, swept source OCT can be said to be an OCT technique of acquiring a spectral distribution of interference light in a time-divisional manner while spectral domain OCT can be said to be an OCT technique of acquiring a spectral distribution of interference light in a space-divisional manner. Those skilled in the art should realize that the OCT techniques applicable to some embodiments are not limited to swept source OCT.

### <Control System and Processing System>

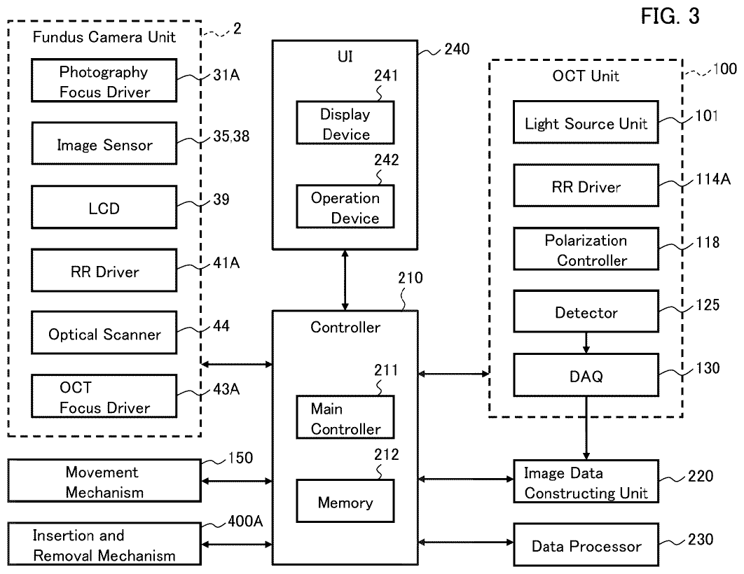

FIG. 3 illustrates an example of the configuration of the control system and the processing system of the ophthalmic apparatus 1. The arithmetic and control unit 200 of some examples includes the controller 210, the image data constructing unit 220, and the data processor 230. Although not shown in the drawings of the present disclosure, the ophthalmic apparatus 1 may further include a communication device, a drive device (reader and/or writer), or like devices.

### <Controller 210>

The controller 210 performs various kinds of controls. The controller 210 includes the main controller 211 and the memory 212. The main controller 211 includes one or more processors and executes a control of an element of the ophthalmic apparatus 1 (the elements shown in FIG. 1 to FIG. 4). The main controller 211 is implemented by cooperation between hardware including the one or more processors and control software. The memory 212 includes one or more storage devices such as a hard disk drive and a solid state drive, and stores data.

The photography focus driver 31A is configured to move the photography focusing lens 31 disposed in the photographing optical path and the focusing optical system 60 disposed in the illumination optical path under control of the main controller 211. The retroreflector driver (RR driver) 41A is configured to move the retroreflector 41 disposed in the sample arm under control of the main controller 211. The OCT focus driver 43A is configured to move the OCT focusing lens 43 disposed in the sample arm under control of the main controller 211. The retroreflector driver (RR driver) 114A is configured to move the retroreflector 114 disposed in the reference arm under control of the main controller 211. The movement mechanism 150 is configured to move the optical system of the ophthalmic apparatus 1 in a three dimensional manner. In other words, the movement mechanism 150 is configured to move the optical system of the ophthalmic apparatus 1 in the x, y, and z directions. The insertion and removal mechanism 400A is configured to insert and remove the attachment 400 into and from the optical path.

### <Image Data Constructing Unit 220>

The image data constructing unit 220 is configured to construct OCT image data of the subject's eye E based on signals (sampling data) input from the data acquisition system 130. The OCT image data thus constructed is one or more pieces of A-scan image data, and for example, is B-scan image data (two dimensional cross sectional image data, two dimensional tomographic image data) consisting of a plurality of pieces of A-scan image data. The image data constructing unit 220 is implemented by cooperation between hardware including one or more processors and image data constructing software.

In order to construct OCT image data from sampling data, the image data constructing unit 220 performs the following processes, as in existing or conventional Fourier domain OCT techniques: a process of applying signal processing to the spectral distribution formed based on the sampling data for each A-line, to generate a reflection intensity profile for each A-line (referred to as an A-line profile); a process of applying visualization processing to each of the A-line profiles to generate a plurality of pieces of A-scan image data; and a process of arranging the plurality of pieces of A-scan image data according to the scanning pattern (the arrangement of the plurality of scan points). The aforementioned signal processing for generating A-line profiles includes noise reduction (denoising), filtering, fast Fourier transform (FFT), and other processing. In the cases in which another type of OCT technique is employed, known OCT image data construction processing is executed in accordance with the OCT technique employed.

The image data constructing unit 220 may be configured to construct three dimensional data that represents a three dimensional region (referred to as a volume) of the subject's eye E. The three dimensional image data is image data in which the positions of the pixels are defined using a three dimensional coordinate system. Examples of the three dimensional image data include stack data and volume data. Stack data is image data formed by arranging a plurality of cross sectional images acquired along a plurality of scan lines, on the basis of the positional relationship between the scan lines. Volume data is image data whose elements (picture elements) are voxels arranged in a three dimensional manner. Volume data is constructed by applying processing such as interpolation and voxelization to stack data, for example. Volume data is also referred to as voxel data.

The image data constructing unit 220 may create new OCT image data from the OCT image data constructed in the way described above. In some aspect examples, the image data constructing unit 220 maybe configured to apply rendering to three dimensional image data. Examples of the rendering include volume rendering, surface rendering, maximum intensity projection (MIP), minimum intensity projection (MinIP), and multi planar reconstruction (MPR).

In some aspect examples, the image data constructing unit 220 may be configured to construct an OCT front image from three dimensional image data. The image data constructing unit 220 of some examples may be configured to construct projection data of three dimensional image data by applying, to the three dimensional image data, projection processing in the z direction (A-line direction, depth direction). Similarly, the image data constructing unit 220 may be configured to construct projection data from partial data of three dimensional image data such as a slab of three dimensional image. This partial data may be automatically designated or set using image segmentation (also simply referred to as segmentation) or manually designated or set by the user, for example. The method or technique employed for this segmentation may be freely selected or determined, and may include, for example, image processing such as edge detection, and/or a segmentation technique using machine learning. The segmentation of the present aspect example may be executed, for example, by the image data constructing unit 220 or the data processor 230.

The ophthalmic apparatus 1 may be capable of performing OCT motion contrast imaging. OCT motion contrast imaging is a technique of imaging motion of fluid (liquid) etc. in an eye (see, for example, Japanese Unexamined Patent Application Publication (Translation of PCT Application) No. 2015-515894). OCT motion contrast imaging is used, for example, to perform OCT angiography (OCTA) for depicting or visualizing blood vessels.

### <Data Processor 230>

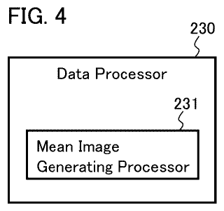

The data processor 230 is configured to perform various kinds of data processing on an image of the subject's eye E. The data processor 230 of some examples is implemented by cooperation between hardware including one or more processors and data processing software. The data processor 230 of the present aspect example includes the mean image generating processor 231 shown in FIG. 4.

To begin with, images input into the processing executed by the mean image generating processor 231 will be described. The ophthalmic apparatus 1 of the present aspect example is configured to apply, to the subject's eye E, a plurality of OCT scans corresponding to a plurality of different polarization conditions. The plurality of polarization conditions may be any of the following types: a single condition group (a group of conditions) determined in advance; one condition group selected from two or more condition groups determined in advance; and a condition group individually determined for the subject's eye E.

In order to apply the plurality of OCT scans corresponding to the plurality of different polarization conditions to the subject's eye E, the ophthalmic apparatus 1 is configured to perform a control of the polarization controller 118 provided in the reference arm and a control of the OCT scanner. The OCT scanner includes the OCT unit 100, the optical scanner 44, etc. With this, a plurality of data sets corresponding to the plurality of different polarization conditions is collected. The image data constructing unit 220 is configured to construct an OCT image from each of the plurality of data sets collected. As a result, a plurality of OCT images corresponding to the plurality of polarization conditions is obtained.

The mean image generating processor 231 is configured to apply averaging to the plurality of OCT images acquired in this way. This averaging processing averages out birefringence-derived artifacts mixed in the plurality of OCT images, thereby generating an image with a reduced birefringence-derived artifact. The resulting image of this averaging is referred to as a mean image.

The averaging is image processing of calculating the averages of pixel values. Any type of calculation may be used for the averaging of the present aspect example. For example, the averaging calculation used for the averaging of the present aspect example may include any one of the following calculation methods: summation averaging (arithmetic mean calculation), weighted arithmetic mean calculation, geometric averaging (geometric mean calculation), and logarithmic averaging (logarithmic mean calculation). Alternatively, the averaging calculation used for averaging of the present aspect example may include any two or more of the summation averaging, weighted arithmetic mean calculation, geometric averaging, and logarithmic averaging. Also, the averaging of the present aspect example may be performed by selectively using two or more types of averaging calculation methods.

The mean image generating processor 231 of some aspect examples may be configured to generate a mean image by performing the averaging only. Further, the mean image generating processor 231 of some aspect examples may be configured to perform one or more other processes in addition to the averaging. In some aspect examples, the mean image generating processor 231 may be configured to perform predetermined processing prior to the averaging (referred to as pre-processing). The type of the pre-processing may be freely selected. Examples of the pre-processing include position matching (or, position adjustment or alignment) between OCT images (referred to as registration), contrast correction of an OCT image, noise reduction of an OCT image, and any processing of other kinds. The mean image generating processor 231 of some aspect examples may be configured to perform predetermined processing after the averaging (referred to as post-processing). The type of the post-processing may be freely selected. Examples the post-processing include contrast correction of a mean image, noise reduction of a mean image, and any processing of other kinds.

The case in which the averaging includes summation averaging is now described. Note that descriptions of the cases in which averaging calculation other than summation averaging is employed will be omitted. Those skilled in the art will be able to understand that actions and effects are obtained according to the characteristics and features of the type of averaging calculation employed.

The summation averaging is averaging calculation performing the following processes for each of a plurality of corresponding pixel groups in a plurality of OCT images (here, each corresponding pixel group is a group consisting of N pieces of pixels selected one-by-one from the N pieces of OCT images): a process of calculating the sum of the values of the plurality of pixels constituting this corresponding pixel groups; and a process of dividing the sum by the number of the plurality of pixels. The summation averaging has the effect of reducing speckle noise occurring in the plurality of OCT images (see, for example, International Publication No. WO 2011/052131). More generally, the summation averaging contributes to the reduction of random noise.

When the averaging includes the summation averaging, the mean image generating processor 231 applies the summation averaging (in a wider sense, averaging including the summation averaging) to the plurality of OCT images corresponding to the plurality of polarization conditions. This generates a mean image with both a reduced birefringence-derived artifact and reduced speckle noise (in a wider sense, a mean image with both a reduced birefringence-derived artifact and reduced random noise). The mean image generated in this way is referred to as an arithmetic mean image.

### <User Interface 240>

The user interface 240 includes the display device 241 and the operation device 242. The display device 241 includes the display device 3. The operation device 242 includes various operation devices and various input devices. The user interface 240 may include a device that has both a display function and an operation function, such as a touch panel. Some embodiment may not include at least part of the user interface 240. For example, a display device may be an external device or a peripheral device that is connected to the ophthalmic apparatus 1.

### <Usage of Mean Image>

The mean image generated by the mean image generating processor 231 is an image with a reduced birefringence-derived artifact and therefore is an image of a higher quality than the original OCT image. Furthermore, the arithmetic mean image is even a higher quality image with reduced speckle noise (random noise) as well as a reduced birefringence-derived. The high quality of the mean image contributes to quality improvement in observation, analysis, evaluation, assessment, etc. The usage of the mean image is not limited to observation, analysis, evaluation, and assessment. Some examples of the ways of using the mean image will be described below. While some examples of the ways of using the arithmetic mean image will be described below, those skilled in the art will understand that other types of mean images can be used in the same manner or like manners.

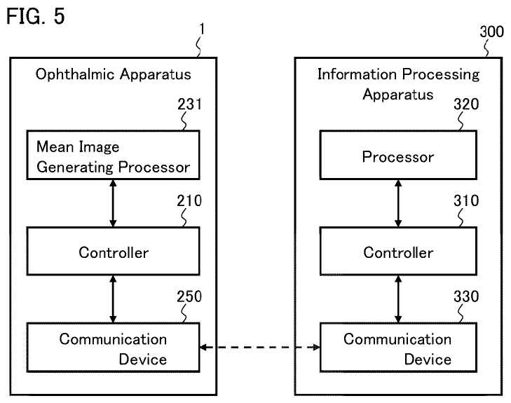

FIG. 5 shows an example of a system that can be employed for using the arithmetic mean image generated by the ophthalmic apparatus 1. In FIG. 5, the configuration of the ophthalmic apparatus 1 is shown in a schematic or simplified manner.

The ophthalmic apparatus 1 of the present example includes the communication device 250 including the communication device mentioned above. The communication device 250 performs data communication with the information processing apparatus 300. The arithmetic mean image generated by the mean image generating processor 231 is transmitted to the information processing apparatus 300 by the communication device 250 under the control of the controller 210. Note that the ophthalmic apparatus 1 of the present example may include a drive device configured to record data on a recording medium instead of or in addition to the communication device 250. The data recorded on the recording medium will be provided to the information processing apparatus 300.

The information processing apparatus 300 is configured to process information provided by the ophthalmic apparatus 1. The information processing apparatus 300 may be a part of the ophthalmic apparatus 1 or may be an apparatus separate from the ophthalmic apparatus 1. The information processing apparatus 300 includes the controller 310, the processor 320, and the communication device 330. The controller 310 performs a control of each part (each element) of the information processing apparatus 300. The processor 320 executes information processing. The communication device 330 performs data communication with the ophthalmic apparatus 1. Note that the information processing apparatus 300 may include a drive device configured to read out data from a recording medium instead of or in addition to the communication device 330.

The data provided from the ophthalmic apparatus 1 to the information processing apparatus 300 includes at least one or more arithmetic mean images, and may further include a plurality of images that have been processed to generate the arithmetic mean images. The plurality of images may be the plurality of OCT images collected by applying the plurality of OCT scans corresponding to the plurality of different polarization conditions to the subject's eye E. A plurality of images processed to generate one arithmetic mean image is referred to as an “original image group” of this arithmetic mean image.

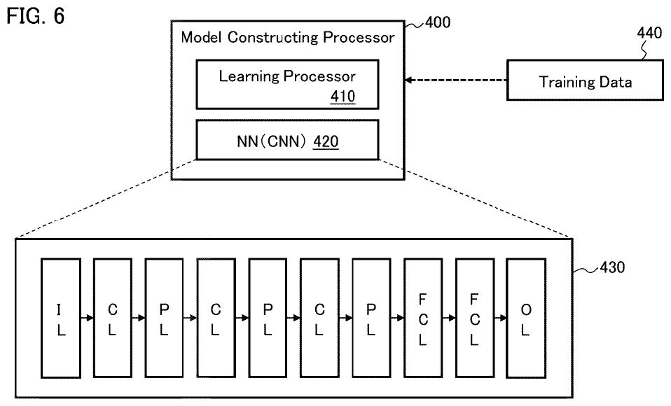

The processor 320 includes the model constructing processor 400 shown in FIG. 6. The model constructing processor 400 executes machine learning using the training data 440 that includes the data provided from the ophthalmic apparatus 1. The machine learning generates a machine learning model that has been trained on the basis of the data provided from the ophthalmic apparatus 1.

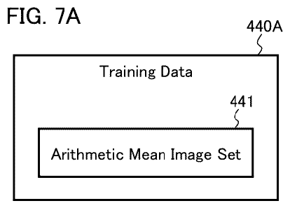

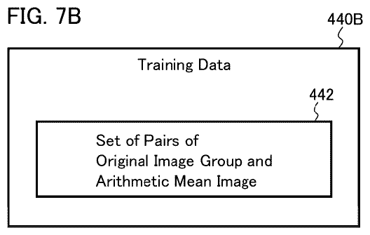

The training data 440 of some aspect examples includes a plurality of arithmetic mean images (referred to as an arithmetic mean image set) (see FIG. 7A). The training data 440 of some aspect examples includes a set of pairs of an arithmetic mean image and its original image group, in other words, a set of pairs of an original image group and an arithmetic mean image produced from the original image group (see FIG. 7B).

The arithmetic mean image set 441 included in the training data 440A of FIG. 7A includes a plurality of arithmetic mean images acquired in the manner described above. Some aspect examples produce all arithmetic mean images included in arithmetic mean image set 441 by means of the ophthalmic apparatus 1 while some other aspect examples produce only a part of the arithmetic mean images included in arithmetic mean image set 441 by means of the ophthalmic apparatus 1. Metadata (e.g., labels, tags, or like data) may be attached to the arithmetic mean images included in the training data 440A. The labels are generated by annotation performed in advance and are assigned to the corresponding arithmetic mean images. The annotation may be performed by one or more of a doctor, a technician, a computer, and another inference model, for example.

In addition to the plurality of arithmetic mean images acquired in the manner described above, the set 442 (that is, the set 442 of pairs of an arithmetic mean image and its original image group) included in the training data 440B of FIG. 7B, includes a plurality of OCT images processed in order to generate each arithmetic mean image (that is, an original image group corresponding to each arithmetic mean image). All of the arithmetic mean images included in the set 442 may be constructed by the ophthalmic apparatus 1, or only one or more (only a proper subset) of the arithmetic mean images may be constructed by the ophthalmic apparatus 1. As mentioned above, both birefringence-derived artifacts and speckle noise (random noise) are reduced in the arithmetic mean images.

Metadata (e.g., labels, tags, or like data) may be attached to the pairs (that is, the pairs of an arithmetic mean image and its original image group) included in the training data 440B. The labels are generated by annotation performed in advance and are assigned to the corresponding pairs. The annotation includes, for example, the process of identifying a birefringence-derived artifact from each original image group. The process of identifying a birefringence-derived artifact may include any one of or both the following processes: the process of detecting a birefringence-derived artifact in an original image group based on the characteristics of birefringence-derived artifacts; and the process of detecting a birefringence-derived artifact in an original image group by comparing an arithmetic mean image with the original image group. Information obtained by the birefringence-derived artifact identification process executed in this way is assigned to the corresponding pair as a label. The annotation of the present example may also be performed by one or more of a doctor, a technician, a computer, and another inference model, for example.

The machine learning model constructed using the training data 440B is a trained model (inference model) configured to function, for example, to receive an OCT image (one or a plurality of OCT images) of an eye and output information on birefringence-derived artifacts. This output information is referred to as birefringence-derived artifact information.

The birefringence-derived artifact information output from the machine learning model constructed using the training data 440B may be an image in which a birefringence-derived artifact (and speckle noise) is (are) eliminated (removed, reduced) from the OCT image input. This output image is similar to a mean image (arithmetic mean image) obtained by the processing executed by the mean image generating processor 231 of the ophthalmic apparatus 1, and is referred to as a quasi-mean image.

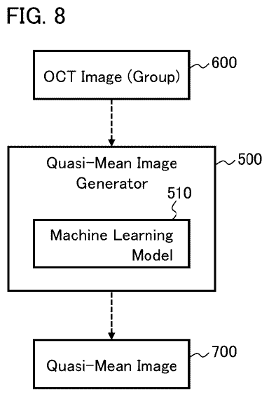

The learning processor 410 of the model constructing processor 400 may construct a machine learning model by applying supervised learning with the training data 440B to the neural network 420. The machine learning model constructed in this way is used, for example, as the machine learning model 510 (at least part of the machine learning model 510) of the quasi-mean image generator 500 of FIG. 8. The quasi-mean image generator 500 is configured to receive the OCT image (group) 600 (including one OCT image or two or more OCT images) of an eye and output the quasi-mean image 700 in which both a birefringence-derived artifact and reduced speckle noise are reduced.

Various methods and techniques are known for machine learning to reproduce, with only a single image, the process of reducing speckle noise by performing summation averaging (arithmetic mean calculation) of a plurality of images. The following documents shows examples of such methods and techniques: Dewei Hu, Joseph D. Malone, Yigit Atay, Yuankai K. Tao, and Ipek Oguz, “Retinal OCT Denoising with Pseudo-Multimodal Fusion Network”, arXiv: 2107. 04288v1 [eess. IV], 9 Jul. 2021; and Jose J. Rico-Jimenez, Dewei Hu, Eric M. Tang, Ipek Oguz, and Yuankai K. Tao, “Real-time OCT image denoising using a self-fusion neural network”, Biomedical optics Express, Vol. 13, Issue 3, pp. 1398-1409 (2022). However, the machine learning according to the present example, that is, the machine learning configured to be capable of reproducing (conducting) the process of reducing both a birefringence-derived artifact and speckle noise by performing summation averaging of a plurality of images with only a single image, is a novel technique.

The quasi-mean image generator 500 may have other functions in addition to the quasi-mean image generating function described above. For example, in addition to the quasi-mean image generating function, the quasi-mean image generator 500 may have a pre-processing function and/or a post-processing function. Examples of the pre-processing function of the quasi-mean image generator 500 include registration of the OCT image group 600, contrast correction of the OCT image (group) 600, noise reduction of the OCT image (group) 600, and so forth. Examples of the post-processing function of the quasi-mean image generator 500 include contrast correction of the quasi-mean image, noise reduction of the quasi-mean image, and so forth.

The birefringence-derived artifact information output from the machine learning model constructed using the training data 440B is not limited to a quasi-mean image. For example, the birefringence-derived artifact information may include one or more of the following kinds of information: a detection result of a birefringence-derived artifact from an OCT image input into the machine learning model; attribute information of a birefringence-derived artifact; a discrimination result between an image of a true structure of a sample and a birefringence-derived artifact (referred to as discrimination information); and image segmentation information regarding a birefringence-derived artifact.

The attribute information of a birefringence-derived artifact is information that represents one or more freely selected or determined properties (characteristics, features) of a birefringence-derived artifact in an OCT image input into the machine learning model. The attribute information of the birefringence-derived artifact may be information on one or more freely selected or determined parameters related to the birefringence-derived artifact, such as the position, size, dimension, shape, intensity, magnitude, or degree of influence of the birefringence-derived artifact. In the present example, the training data 440B includes labels generated by annotation related to the attributes of birefringence-derived artifacts in OCT images, and the machine learning model is trained and configured to receive an OCT image and output attribute information.

The discrimination information is information obtained by processing of discriminating (identifying, distinguishing) between an image derived from a true structure of a sample and a birefringence-derived artifact. The image derived from the true structure of the sample is referred to as a structure-derived image. The OCT image input into the machine learning model is an image produced by applying an OCT scan to the sample. OCT images ideally contain only structure-derived images which represent the structures of samples. However, OCT images in reality often contain artifacts such as birefringence-derived artifacts. For example, OCT images produced by applying OCT scans to eyes ideally contain only structure-derived images which are images of the true structures of the eyes (e.g., tissues of the eyes, sites or regions of the eyes, artificial objects implanted in the eyes, etc.). In reality, however, OCT image produced by applying OCT scans to eyes often contain artifacts. Here, examples of the artificial objects include an intraocular lens (IOL), an intraocular contact lens (ICL), a minimally invasive glaucoma surgery (MIGS) device, and so forth. The discrimination information is, for example, information on a freely selected or determined position (e.g., a freely selected or determined pixel, a freely selected or determined pixel group (pixels), a freely selected or determined image region, etc.) in an OCT image, and includes information showing whether the position corresponds to a structure-derived image or a birefringence-derived artifact. More specifically, the discrimination information may be information that includes identifiers assigned to individual pixels of an OCT image of an eye. Each identifier indicates a discrimination result that the corresponding pixel is a pixel of a structure-derived image or that the corresponding pixel is a pixel of a birefringence-derived artifact. Examples of the form of such information include discrimination list information, discrimination table information, and discrimination map information. The identifiers representing that corresponding pixels are pixels of structure-derived images, may include (may be classified into) identifiers representing that corresponding pixels belong to images of tissues (sites) of the eye and identifiers representing that corresponding pixels belong to images of artificial objects implanted in the eye. Further, the identifiers representing that corresponding pixels belong to images of tissues (sites) of the eye, may include different identifiers for different tissues (different sites). Similarly, the identifiers representing that corresponding pixels belong to images of artificial objects, may include different identifiers for different kinds of artificial objects. Identifiers used in the present example are not limited to the identifiers representing that corresponding pixels belong to images of tissues (sites) of the eye and the identifiers representing that corresponding pixels belong to images of artificial objects. For example, the present example may employ identifiers indicating pixels whose discrimination has failed, and identifiers showing the qualities of the result of discrimination such as confidence (certainty), reliability, and accuracy. In the present example, the training data 440B includes labels generated by annotation related to discrimination between structure-derived images and birefringence-derived artifacts in OCT images, and the machine learning model is trained and configured to receive an OCT image and output discrimination information.

The image segmentation information includes information obtained by image segmentation performed using the machine learning model. The image segmentation is image processing of partitioning an image into multiple segments (multiple regions, multiple pixel groups). The method or technique used for the image segmentation of the present aspect example may be freely selected or determined, and may include, for example, any of semantic segmentation, instance segmentation, panoptic segmentation, and like techniques. Also, the image segmentation of the present aspect example may be implemented by means of any known segmentation technique, or any combination of known segmentation techniques, such as thresholding, clustering, dual clustering, histograms, edge detection, region-growing, partial differential equations, calculus of variations, graph partitioning, watershed algorithms, and so forth. In the present example, the training data 440B includes labels generated by annotation related to image segmentation of OCT images, and the machine learning model is trained and configured to receive an OCT image and output image segmentation information.

Described next are details of an example of the model constructing processor 400 configured to construct a machine learning model as described above. The training data 440 used for machine learning performed by the model constructing processor 400 may include a mean image (an arithmetic mean image) and may include a plurality of images (an original image group) acquired by applying a plurality of OCT scans corresponding to a plurality of different polarization conditions to an object. One or more of the images included in the training data 440 may be images themselves acquired by actually conducting OCT scans (unprocessed images), and/or, one or more of the images included in the training data 440 may be images produced by applying processing to unprocessed images acquired by actually conducting OCT scans (processed images).

A machine learning model of some aspect examples is configured to receive an OCT image obtained by applying an OCT scan to a sample (human living eye) and to output birefringence-derived artifact information in the OCT image. As mentioned above, the birefringence-derived artifact information may include a quasi-mean image, attribute information, discrimination information, image segmentation information, or information of other kinds.

The model constructing processor 400 shown in FIG. 6 includes the learning processor 410 and the neural network 420.

In some typical examples, the neural network 420 includes a convolutional neural network (CNN). The reference character 430 in FIG. 6 denotes an example of the structure of this convolutional neural network.

An image is input into the input layer of the convolution neural network 430. Behind the input layer, a plurality of pairs of a convolutional layer and a pooling layer is disposed. While three pieces of pairs of a convolution layer and a pooling layer are provided in the convolution neural network 430 shown in FIG. 6, the number of the pairs may be freely selected or determined.

In the convolutional layer, a convolution operation is performed to detect or extract a feature (e.g., contour) from the input image. This convolution operation is a multiply-accumulate operation (a multiply-add operation, a product-sum operation) on the input image. This multiply-accumulate operation is performed with a filter function (a weight coefficient, a filter kernel) having the same dimension as the input image. In the convolutional layer, the convolution operation is applied to individual parts (individual sections, individual portions) of the input image. More specifically, the convolutional layer is configured to calculate a product by multiplying the value of each pixel in a partial image, to which the filter function has been applied, by the value (weight) of the filter function corresponding to this pixel, and then calculate the sum of the products over a plurality of pixels in this partial image. The sum of products obtained in this way is substituted for the corresponding pixel in an image to be output from the convolutional layer. By repetitively performing such multiply-accumulate operation in parallel with moving sites (parts) to which the filter function is applied (that is, in parallel with changing or switching partial images of the input image), a result of the convolution operation for the entire input image is obtained. The convolution operation performed in this way gives a large number of images in which various features have been extracted using a large number of weight coefficients. This means that a large number of filtered images, such as smoothed images and edge images, are obtained. The large number of images generated by the convolutional layer are referred to as feature maps.

The pooling layer executes data compression (e.g., data thinning) of the feature maps generated by the convolutional layer disposed at the immediately preceding position. More specifically, the pooling layer calculates statistical values in predetermined neighboring pixels of a predetermined pixel of interest in an input feature map at each predetermined pixel intervals, and outputs an image having a size smaller than the input feature map. The statistical values applied to the pooling operation may be maximum values (max pooling) or average values (average pooling), for example. The value of the pixel intervals applied to the pooling operation is referred to as a stride.

Typically, a convolutional neural network extracts many features from an input image by executing processing using a plurality of pairs of a convolutional layer and a pooling layer.

A fully connected layer is disposed behind the most downstream pair of a convolutional layer and a pooling layer. While two pieces of fully connected layers are provided in the example shown in FIG. 6, the number of fully connected layers may be freely selected or determined. The fully connected layer executes processing such as image classification, image segmentation, or regression using the features compressed by the combination of convolution and pooling. An output layer is disposed behind the most downstream fully connected layer. The output layer gives an output result.

Some aspect examples may employ a convolutional neural network including no fully connected layer. For example, some aspect examples may employ a fully convolutional network (FCN). In addition, or alternatively, some aspect examples may include a support vector machine, a recurrent neural network (RNN), or any other models. Further, machine learning applied to the neural network 420 may include transfer learning. In other words, the neural network 420 may include a neural network that has already been trained using other training data (training images) and whose parameters have been adjusted (tuned). Further, the model constructing processor 400 (the learning processor 410) may be configured in such a manner that fine tuning can be applied to a trained neural network (at least part of the neural network 420). The neural network 420 may be constructed, for example, using a known open source neural network architecture.

The learning processor 410 applies machine learning with the training data 440 to the neural network 420. In the case in which the neural network 420 includes a convolutional neural network, parameters tuned by the learning processor 410 include, for example, filter coefficients of one or more convolutional layers therein and connection weights and offsets of one or more fully connected layers therein.

The types or kinds of images included in the training data 440 are not limited to a mean image, and an original image group which is a plurality of images acquired by applying a plurality of OCT scans corresponding to a plurality of different polarization conditions to an object. In some examples, the training data 440 may include any of the following images: an OCT image of any kind; an image acquired using other kinds of ophthalmic modalities (e.g., fundus camera, slit lamp microscope, SLO, surgical microscope); an image acquired using any kinds of diagnostic imaging modalities of any clinical departments (e.g., ultrasonic diagnostic apparatus, X-ray diagnostic apparatus, X-ray computed tomography (CT) apparatus, magnetic resonance imaging (MRI) apparatus); an image produced by processing an actual image of an eye (processed image data); an image generated by a computer; a pseudo image; and images of any other kinds. Further, the number of pieces of data included in the training data 440 may be increased by using any technique such as data augmentation.

The method or technique of the machine learning used in the present aspect example is, for example, supervised learning, but is not limited thereto. Some aspect examples may employ any known method and technique, in addition to or instead of supervised learning, such as unsupervised learning, reinforcement learning, semi-supervised learning, transduction, and multi-task learning.

In order to prevent the overconcentration of processes in a specific unit of the neural network 420, the learning processor 410 may randomly select and invalidate one or more units of the neural network 420 and execute learning using the remaining units. Such a function is referred to as dropout.

The method or technique of the machine learning used in the present aspect example is not limited to the examples shown above. In some aspect examples, any known methods and techniques such as the following options may be employed in order to construct an inference model: support vector machine, Bayes classifier, boosting, k-means clustering, kernel density estimation, principal component analysis, independent component analysis, self-organizing map (or self-organizing feature map), random forest (or randomized trees, random decision forests), and generative adversarial network (GAN).

### <Modes of OCT Scans>

Some embodiments are configured to generate a mean image with a reduced birefringence-derived artifact by applying averaging to a plurality of OCT images acquired by applying, to a sample, a plurality of OCT scans corresponding to a plurality of different polarization conditions. The mode of the OCT scans conducted to acquire the plurality of OCT images may be freely selected or determined.

For example, the ophthalmic apparatus 1 of the present aspect example applies a plurality of OCT scans corresponding to a plurality of different polarization conditions to the subject's eye E. In order to perform the plurality of OCT scans, the main controller 211 executes a combination control of a control of the polarization controller 118 and a control of the OCT scanner (the OCT unit 100, the optical scanner 44, etc.). With this operation, a plurality of OCT images corresponding to the plurality of different polarization conditions is acquired. The OCT scanning mode performed under a combination of a control of a polarization modulator and a control of an OCT scanner, like the above-described combination control of the present aspect example, is referred to as polarization-modulated OCT scanning.

In some aspect examples, the polarization-modulated OCT scanning may be combined with another OCT scanning mode. In some examples, the polarization-modulated OCT scanning can be combined with an OCT scanning mode of performing a series of OCT scans to redundantly collect data from a sample. The OCT scanning mode for redundant data collection is referred to as redundant OCT scanning. The redundant OCT scanning is an OCT scanning mode of applying an OCT scan a plurality of times to each of one or more locations in the sample. In other words, the redundant OCT scanning is an OCT scanning mode of performing a plurality of times of data acquisition from each of one or more locations in the sample.

One example of the redundant OCT scanning is Lissajous scanning described, for example, in Japanese Unexamined Patent Application Publication No. 2021-040854. Lissajous scanning is an OCT scanning mode that enables correction of an artifact caused by movement or motion of a sample (referred to as a motion artifact) by performing redundant data acquisition from each position where cycles intersect each other.

In an OCT scanning mode, in which scanning is performed according to a pattern having one or more intersections, as in Lissajous scanning, speckle noise can be reduced by calculating an arithmetic mean of a plurality of image regions corresponding to each intersection (referred to as a plurality of intersecting regions) in the process of registration of the intersecting regions.

Combining the polarization-modulated OCT scanning with Lissajous scanning makes it possible to reduce both speckle noise and a birefringence-derived artifact in the plurality of intersecting regions corresponding to each intersection. For example, changing a polarization condition for each cycle, that is, switching a polarization condition from cycle to cycle, can reduce both speckle noise and a birefringence-derived artifact in the intersecting region between cycles. This makes it possible to improve the quality of motion artifact correction using the intersecting region and therefore to improve the quality of an image constructed by the Lissajous scanning. Note that the changing or switching of polarization conditions may be applied to all cycles or to only one or more cycles (only a proper subset of all cycles).

As described above, in the OCT scanning mode of the present example, which is a combination of the Lissajous scanning and the polarization-modulated OCT scanning, a series of scans is performed based on a plurality of cycles intersecting each other in order to perform a series of scans (Lissajous scanning) of redundantly collecting data from a sample. In other words, the series of OCT scans performed as Lissajous scanning is operated to redundantly collect data from the sample based on a scanning pattern (a Lissajous pattern) that includes a plurality of partial patterns (a plurality of cycles) intersecting each other. The Lissajous pattern is a two dimensional pattern generated as a Lissajous curve obtained by synthesizing or combining two simple harmonic motions that are perpendicular to each other.

Furthermore, the OCT scanning mode of the present example performs a plurality of OCT scans corresponding to a plurality of different polarization conditions in parallel with the Lissajous scanning. That is, the OCT scanning mode of the present example performs the polarization-modulated OCT scanning in parallel with the Lissajous scanning. Here, the plurality of OCT scans of the polarization-modulated OCT scanning is included in the series of scans of the Lissajous scanning. In other words, the OCT scanning mode of the present example may be performed by applying the changing of the polarization conditions of the polarization-modulated OCT scanning to all cycles of the Lissajous scanning, or by applying the changing of the polarization conditions of the polarization-modulated OCT scanning to only one or more cycles (only a proper subset of all cycles) of the Lissajous scanning.

A series of OCT scans performed in such a manner as to redundantly collect data from a sample based on a scanning pattern that includes a plurality of partial patterns intersecting each other, is not limited to Lissajous scanning performed in such a manner as to redundantly collect data from a sample based on a Lissajous pattern that includes a plurality of cycles intersecting each other.

Another example of redundant OCT scanning is OCT angiography (OCTA) described, for example, in Japanese Unexamined Patent Application Publication No. 2020-049147. OCT angiography is an angiography technique (a technique of visualizing blood vessels) by utilizing motion contrast imaging technology. OCT angiography generates an image by performing the following processes: a process of performing an OCT scan a plurality of times targeting the same region of a sample to acquire a plurality of OCT images; and a process of extracting components that changes during scanning time intervals between the plurality of OCT images acquired. The components extracted are, for example, differences, changes in signal intensity, changes in phase, or other parameters. In between (the acquisition time of) the plurality of OCT images, static structures such as ocular tissues exhibit only very small amounts of changes while dynamic structures such as red blood cells in blood vessels exhibit significant amounts of changes. Therefore, visualizing the change signals of magnitudes equal to or greater than a predetermined threshold value makes it possible to selectively depict blood flow components.

In an OCT scanning mode, like OCT angiography, in which an OCT scan is performed a plurality of times targeting the same region of a sample, speckle noise can be reduced by calculating an arithmetic mean of a plurality of OCT images collected by the plurality of OCT scans.

Combining the polarization-modulated OCT scanning with such OCT angiography makes it possible to reduce not only speckle noise but also birefringence-derived artifacts. For example, in the case where an OCT scan is performed four times on the same region of a sample in OCT angiography, four different polarization conditions are applied to the four OCT scans, respectively. The four different polarization conditions correspond respectively to the following four different angles with respect to a predetermined direction: the first angle such as 0 degrees, the second angle such as 45 degrees, the third angle such as 90 degrees, and the fourth angle such as 135 degrees. The first angle is applied to the OCT scan of the first time of the four times, the second angle is applied to the OCT scan of the second time, the third angle is applied to the OCT scan of the third time, and the fourth angle is applied to the OCT scan of the fourth time. By calculating an arithmetic mean of the four OCT images corresponding to the four polarization conditions obtained in this way, an image can be generated in which both speckle noise and a birefringence-derived artifact have been reduced.

As described above, in the OCT scanning mode of the present example that is a combination of OCT angiography and polarization-modulated OCT scanning, a plurality of OCT scans targeting the same region of a sample is performed as a series of scans of collecting redundant data of the sample (that is, as OCT angiography). Individuals of the plurality of OCT scans targeting the same region of the sample are performed according to a predetermined scanning pattern. This scanning pattern is, for example, a three dimensional scan (a volume scan) such as a raster scan. Thus, a series of OCT scans performed as OCT angiography redundantly collects data of a sample by applying an OCT scan based on a predetermined scanning pattern (such as a raster scan) a plurality of times targeting the same region of the sample.

Furthermore, in the OCT scanning mode of the present example, a plurality of OCT scans corresponding to a plurality of different polarization conditions (polarization-modulated OCT scanning) is performed in parallel with such OCT angiography. Here, the plurality of OCT scans of the polarization-modulated OCT scanning is included in a series of scans in the OCT angiography. In other words, in the OCT scanning mode of the present example, the changing of the polarization condition in the polarization-modulated OCT scanning may be applied to all OCT scans of the OCT angiography (e.g., all B-scans consisting of the raster scan), or to only one or more OCT scans (only a proper subset of all OCT scans) of the OCT angiography.

Some application examples of OCT scanning that is a combination of OCT angiography and polarization-modulated OCT scanning is described hereinafter. Such combined OCT scanning is referred to as multi-OCT scanning. While the processes according to the application examples below relate to the field of ophthalmology, same or similar processes may also be applied to processes of other fields. In addition, although the processes according to the application examples below relate to specific ocular tissues, same or similar processes may also be applied to processes relating to other ocular tissues or to processes relating to living tissues other than ocular tissues. In addition to the advantages of being able to save time and effort in comparison to the cases of performing OCT angiography and polarization-modulated OCT scanning separately, multi-OCT scanning has advantages for individual applications.

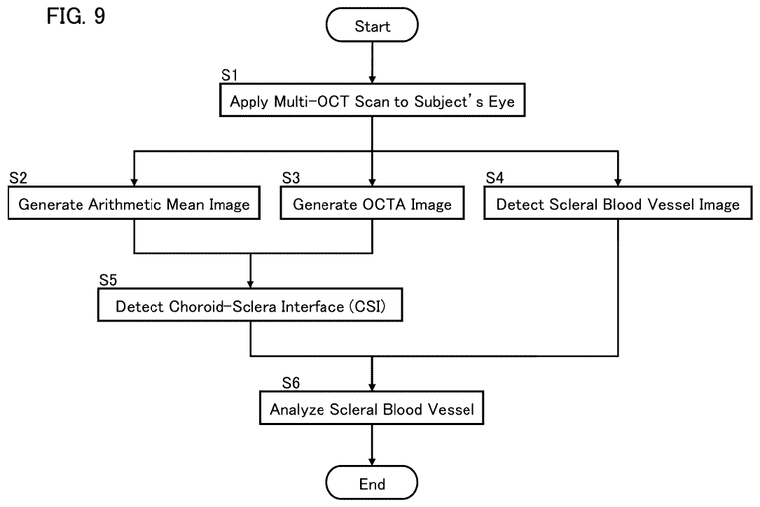

To begin with, the first application example is now described. The present example utilizes multi-OCT scanning to perform scleral blood vessel analysis of the subject's eye E. FIG. 9 shows the flow of the processes of the present example. The ophthalmic apparatus 1 in the present example firstly applies a multi-OCT scan to the subject's eye E (S1). In the multi-OCT scan, OCT angiography and polarization-modulated OCT scanning are performed in parallel.

Based on a data set collected from the subject's eye E by the multi-OCT scan of the step S1, the ophthalmic apparatus 1 (and/or the information processing apparatus 300) generates an arithmetic mean image (S2), generates an OCTA image (S3), and detects a scleral blood vessel image (S4). The arithmetic mean image is generated by the mean image generating processor 231. The OCTA image is generated using a known OCT angiography technique. The scleral blood vessel image is an image derived from scleral blood vessels of the subject's eye E (that is, a structure-derived image of sceral blood vessels), and is obtained, for example, as the discrimination information or the image segmentation information described above. Note that the sceral blood vessel image obtained in the step S4 may include a choroidal blood vessel image.

Next, the ophthalmic apparatus 1 (and/or the information processing apparatus 300) detects a choroid-sclera interface (CSI) based on the arithmetic mean image generated in the step S2 and the OCTA image generated in the step S3 (S5). The detection of the choroid-sclera interface may be performed, for example, by utilizing the highness (large magnitude) of the intensities of OCTA signals corresponding to choroid which has a dense vascular network. More specifically, the detection of the choroid-sclera interface may be performed by the following processes: a process of discriminating between a choroidal region and a scleral region using the OCTA image generated in the step S3 to identify the choroid-sclera interface in the OCTA image (here, the choroidal region refers to an image region corresponding to the choroid and the scleral region refers to an image region corresponding to the sclera); and a process of identifying a region in the arithmetic mean image corresponding to the choroid-sclera interface in the OCTA image. This yields a detection result of the choroid-sclera interface in the arithmetic mean image. Note that both the arithmetic mean image and the OCTA image are generated based on the same data set collected from the subjects eye E by the multi-OCT scan performed in the step S1. This means that there is a trivial correspondence between the positions (coordinates) in the arithmetic mean image and the positions (coordinates) in the OCTA image. Using this trivial correspondence, the region in the arithmetic mean image that corresponds to the choroid-sclera interface in the OCTA image can be identified.

Next, the ophthalmic apparatus 1 (and/or the information processing apparatus 300) performs scleral blood vessel analysis based on the scleral blood vessel image detected in the step S4 and the choroid-sclera interface detected in the step S5 (S6). In the step S6, first of all, the choroid-sclera interface detected in the step S5 is used to remove a choroid blood vessel image (and like images) from the sceral blood vessel image detected in the step S4. As a result of this, an image that is properly derived from scleral blood vessels is extracted from the scleral blood vessel image detected in the step S4. The resulting image is referred to as a corrected scleral blood vessel image. Further, in the step S6, scleral blood vessel analysis is performed based on the corrected scleral blood vessel image. The scleral blood vessel analysis may be any analysis processing relating to scleral blood vessels. For example, the scleral blood vessel analysis may be quantitative analysis of the morphology of sceral blood vessels. Examples of parameters used for the quantitative morphological analysis of sceral blood vessels include thickness, density, curvature, and tortuosity of sceral blood vessels.

According to the first application example described above, the use of multi-OCT scanning (which is a combination of OCT angiography and polarization-modulated OCT scanning) makes it possible to perform scleral blood vessel analysis by focusing on an image that is properly derived from scleral blood vessels (that is, by focusing on a corrected scleral blood vessel image). In addition to this, the use of a high-quality OCT image with a reduced birefringence-derived artifact and reduced speckle noise (that is, the used of an arithmetic mean image) allows to improve the quality (e.g., accuracy, precision, reproducibility, etc.) of scleral blood vessel analysis.

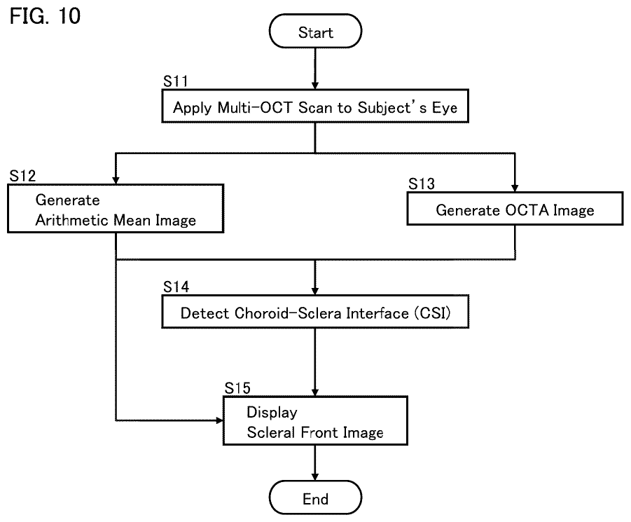

Next, the second application example will be described. The present example utilizes multi-OCT scanning to display a front image (enface slice) of the sclera of the subject's eye E. FIG. 10 shows the flow of the processes of the present example. The ophthalmic apparatus 1 in the present example, first of all, applies a multi-OCT scan to the subject's eye E (S11). In the multi-OCT scan, OCT angiography and polarization-modulated OCT scanning are performed in parallel.

Based on a data set collected from the subject's eye E by the multi-OCT scan of the step S11, the ophthalmic apparatus 1 (and/or the information processing apparatus 300) generates an arithmetic mean image (S12) and generates an OCTA image (S13). The arithmetic mean image is generated by the mean image generating processor 231. The OCTA image is generated using a known OCT angiography technique.

Next, the ophthalmic apparatus 1 (and/or the information processing apparatus 300) detects a choroid-sclera interface (CSI) based on the arithmetic mean image generated in the step S12 and the OCTA image generated in the step S13 (S14). The detection of the choroid-sclera interface may be performed in the same manner as the step S5 of the first application example.

Next, the ophthalmic apparatus 1 (and/or the information processing apparatus 300) generates and displays a scleral front image based on the arithmetic mean image generated in the step S12 and the choroid-sclera interface detected in the step S14 (S15). In the step S15, first of all, an image region corresponding to the sclera (referred to as a sclera region) in the arithmetic mean image generated in the step S12 is identified based on the choroid-sclera interface detected in the step S14. Further, a scleral front image is generated in the step S15 by applying image projection to a partial region (a slab) of the scleral region identified. The scleral front image generated in this way is then displayed on the display device 241 or another display device. The slab may be set automatically or manually. The number of slabs to be set may be freely determined, and the number of scleral front images to be generated and displayed may also be freely determined. The sceral front image displayed is used for various purposes such as sclera observation and sclera analysis (e.g., scleral blood vessel analysis).

According to the second application example described above, the use of multi-OCT scanning (which is a combination of OCT angiography and polarization-modulated OCT scanning) makes it possible to produce and display an image that is properly derived from the sclera (that is, a structure-derived image of the sclera). In addition to this, the use of a high-quality OCT image with a reduced birefringence-derived artifact and reduced speckle noise (that is, the used of an arithmetic mean image) allows to generate and display a structure-derived image of the sclera having improved quality.

Information generated based on a data set collected by multi-OCT scanning, which is a combination of OCT angiography and polarization-modulated OCT scanning, is not limited to those described above. In some examples, a polarization-independent image may be generated based on two images, the polarization directions of which are perpendicular to each other, acquired by polarization-modulated OCT scanning in multi-OCT scanning. Methods and techniques for generating a polarization-insensitive image are known. See, for example, the formula (5) in the following document: Shuichi Makita, Toshihiro Mino, Tastuo Yamaguchi, Mashiro Miura, Shinnosuke Azuma, and Yoshiaki Yasuno, “Clinical prototype of pigment and flow imaging optical coherence tomography for posterior eye investigation”, Biomedical Optics Express, Vol. 9, Issue 9, pp. 4372-4389 (2018). In some examples, the polarization-independent image generated in this way may be used instead of or in addition to the arithmetic mean image in the first application example, and/or, the polarization-independent image may be used instead of or in addition to the arithmetic mean image in the second application example.

OCT angiography is not the only example of a series of OCT scans performed in order to redundantly collect data from a sample by applying an OCT scan based on a predetermined scanning pattern a plurality of times targeting the same region of the sample.

In some examples, polarization-modulated OCT scanning may be combined with repetitive OCT scanning for averaging, which has conventionally been performed for the purpose of speckle noise reduction, that is, which has conventionally been performed without considering and focusing on birefringence-derived artifacts.

In addition, by combining polarization-modulated OCT scanning with panoramic OCT scanning (also referred to as montage OCT scanning) described in Japanese Unexamined Patent Application Publication No. 2020-048825, both a birefringence-derived artifact and speckle noise in an overlapping region (intersecting region, margin) between adjacent OCT images obtained by panoramic OCT scanning, can be reduced.

### <Operation of Ophthalmic Apparatus>

Some examples of the operation of the ophthalmic apparatus 1 will described hereinafter.

### First Operation Example

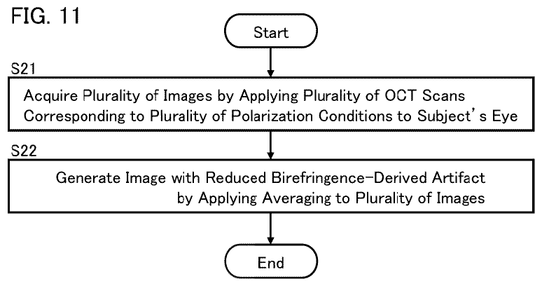

The first example of the operation of the ophthalmic apparatus 1 will be described with reference to FIG. 11.

It is assumed that scan preparation operations such as patient ID input, alignment, and focus adjustment have already been carried out. Further, the operation mode of the ophthalmic apparatus 1 for performing polarization-modulated OCT scanning is selected or designated. In the polarization-modulated OCT scanning, a plurality of OCT scans corresponding to a plurality of different polarization conditions is applied to the subject's eye E. The plurality of polarization conditions may be a single condition group determined in advance, one condition group selected from two or more condition groups determined in advance, or a condition group individually determined for the subject's eye E.

### (S21: Acquire Plurality of OCT Images of Subject's Eye)

The ophthalmic apparatus 1 performs a control of the polarization controller 118 and a control of the OCT scanner (the OCT unit 100, the optical scanner 44, etc.) according to the aforementioned operation mode. By performing these controls, the ophthalmic apparatus 1 applies a plurality of times of OCT scans corresponding to a plurality of different polarization conditions to the subject's eye E, and constructs a plurality of OCT images.

The OCT scans performed in the step S21 may be polarization-modulated OCT scanning, or OCT scanning that is a combination of polarization-modulated OCT scanning and one or more other OCT scanning modes. Some examples of the types of OCT scanning modes that can be combined with polarization-modulated OCT scanning are given above; however, OCT scanning modes capable of combining with polarization-modulated OCT scanning are not limited to these examples.

(S22: Generate Image with Reduced Birefringence-Derived Artifact)

Next, the mean image generating processor 231 of the ophthalmic apparatus 1 generates an image (mean image) with a reduced birefringence-derived artifact by applying predetermined averaging processing to the plurality of OCT images acquired in the step S21.

The type of the averaging processing performed in the step S22 may be freely determined, and may be summation averaging, for example. In the case where the averaging processing includes summation averaging, the image generated in the step S22 is a mean image (an arithmetic mean image) in which both a birefringence-derived artifact and speckle noise have been reduced.

### Second Operation Example

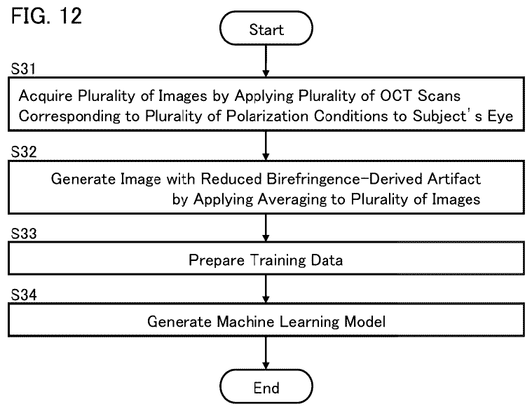

The second example of the operation of the ophthalmic apparatus 1 will be described with reference to FIG. 12. The scan preparation operations and the operation mode designation may be performed in the same manner as those of the first operation example.

### (S31: Acquire Plurality of OCT Images of Subject's Eye)

In the same or similar manner as in the step S21 of the first operation example, the ophthalmic apparatus 1 constructs a plurality of OCT images of the subject's eye E corresponding to a plurality of different polarization conditions. The type of OCT scanning performed in the step S31 may also be the same as or similar to that in the step S21 of the first operation example.

(S32: Generate Image with Reduced Birefringence-Derived Artifact)

Next, in the same or similar manner as in the step S22 of the first operation example, the mean image generating processor 231 of the ophthalmic apparatus 1 generates a mean image with a reduced birefringence-derived artifact by applying predetermined averaging processing to the plurality of OCT images acquired in the step S31. It is assumed that the image generated in the present example is an arithmetic mean image in which both a birefringence-derived artifact and speckle noise have been reduced.

### (S33: Prepare Training Data)

Next, training data to be used for machine learning to construct a machine learning model is prepared. The training data includes the plurality of OCT images acquired by applying the plurality of OCT scans corresponding to the plurality of different polarization conditions to an object.

In particular, the training data of the present example includes the arithmetic mean image generated in the step S32. Further, the training data in the present example includes a pair of the arithmetic mean image generated in the step S32 and its original image group. Here, the original image group is the plurality of OCT images acquired in the step S31.

The steps S31 and S32 are executed a plurality of times by the ophthalmic apparatus 1 and another ophthalmic apparatus. The repetition of the steps S31 and S32 produces a plurality of arithmetic mean images and a plurality of original image groups corresponding thereto. The arithmetic mean images and the original image groups are used to create the training data.

As a result, the training data prepared by the present example includes a plurality of pieces of pairs of an original image group (a plurality of OCT images corresponding to a plurality of different polarization conditions) and an arithmetic mean image produced from the corresponding original image group. In other words, the training data prepared by the present example includes a set of pairs, wherein each pair includes an original image group (a plurality of OCT images corresponding to a plurality of different polarization conditions) and an arithmetic mean image generated from this original image group.

The types of images included in the training data may be freely selected or determined and may include, as described above, any one or more of the following types of images: an image of an eye acquired by OCT scanning; an image of an eye acquired by a modality other than OCT; an image created by processing an image of an eye; an image generated by computer graphics; an image generated by data augmentation; and a pseudo image.

In addition, any matters and items described in the present disclosure regarding training data, machine learning, a machine learning model, and so forth, may be combined with the present example. Furthermore, any known matters and items related to training data, machine learning, machine learning models, and so forth, may be applied to the present example.

### (S34: Generate Machine Learning Model)

Next, for example, the model constructing processor 400 (the processor 320) generates a machine learning model by applying machine learning that uses the training data obtained in the step S33 to a neural network. This machine learning model is configured and operated to receive an OCT image and output an image with both a reduced birefringence-derived artifact and reduced speckle noise. The number of OCT images input into the machine learning model may be freely selected or determined, and may be one, or two or more.

The machine learning model generated in the step S34 is provided to an ophthalmic apparatus, an information processing apparatus, and other apparatuses and systems. The machine learning model may be used as the quasi-mean image generator 500 of FIG. 8, for example.

### Advantageous Effects

Several non-limiting advantageous effects of the present aspect example will be described below.

According to the present aspect example, the ophthalmic apparatus 1 is capable of acquiring a plurality of OCT images by applying a plurality of OCT scans corresponding to a plurality of different polarization conditions to a sample (eye), and applying averaging to the plurality of OCT images to generate a mean image with a reduced birefringence-derived artifact.

Thus, the present aspect example provides a novel technique of generating an image with a reduced birefringence-derived artifact from images acquired by an OCT modality without the polarization separation detection function like the ophthalmic apparatus 1.

Various kinds of matters and items described in the present aspect example can provide various kinds of examples for improving the function of generating an image with a reduced birefringence-derived artifact, various kinds of examples of applications of a generated image with a reduced birefringence-derived artifact, various kinds of examples of a plurality of OCT scans corresponding to a plurality of different polarization conditions (that is, various kinds of examples of polarization-modulated OCT scanning), and so forth.

### <Program and Recording Medium>

A program can be configured that causes a computer to execute the OCT image processing method implemented by the image processing apparatus (the ophthalmic apparatus 1) according to the aspect examples described thus far. Any of the matters and items described in the aspect examples described above may be combined with the program.

In addition, a computer-readable non-transitory recording medium can be configured that stores the program described above. Any of the matters and items described in the aspect examples described above can be combined with the recording medium. The non-transitory recording medium may be in any form, and examples thereof include magnetic disks, optical disks, magneto-optical disks, and semiconductor memories.

While certain embodiments have been described, these embodiments have been presented by way of example only, and are not intended to limit the scope of the inventions. Indeed, the novel embodiments described herein may be embodied in a variety of other forms; furthermore, various omissions, substitutions, additions and changes in the form of the embodiments described herein may be made without departing from the spirit of the inventions. The accompanying claims and their equivalents are intended to cover such forms or modifications as would fall within the scope and spirit of the inventions.

1. A method of processing an optical coherence tomography (OCT) image, the method comprising:
acquiring a plurality of images by applying a plurality of OCT scans corresponding to a plurality of different polarization conditions to a sample; and
generating a mean image with a reduced birefringence-derived artifact by applying averaging to the plurality of images corresponding to the plurality of different polarization conditions.

2. The method according to claim 1, wherein
the averaging includes summation averaging, and
the generating the mean image includes generating an arithmetic mean image with both the reduced birefringence-derived artifact and reduced speckle noise by applying the averaging including the summation averaging to the plurality of images corresponding to the plurality of different polarization conditions.

3. The method according to claim 2, further comprising generating a machine learning model by performing machine learning using training data that includes the arithmetic mean image.

4. The method according to claim 3, wherein the training data includes a set of pairs of a plurality of images corresponding to a plurality of different polarization conditions and an arithmetic mean image based on this plurality of images.

5. The method according to claim 4, wherein the machine learning model generated by the machine learning using the training data receives at least one OCT image and outputs an image with both a reduced birefringence-derived artifact and reduced speckle noise.

6. The method according to claim 1, wherein the plurality of OCT scans corresponding to the plurality of different polarization conditions is included in a series of OCT scans to redundantly collect data from the sample.

7. The method according to claim 6, wherein the series of OCT scans performs redundant data collection from the sample by using a first scan pattern that includes a plurality of partial patterns intersecting each other.

8. The method according to claim 6, wherein the series of OCT scans performs redundant data collection from the sample by applying an OCT scan based on a second scan pattern a plurality of times targeting a same region of the sample.

9. An apparatus of processing an optical coherence tomography (OCT) image, the apparatus comprising:
an image acquiring unit including an OCT scanner and configured to acquire a plurality of images generated by applying a plurality of OCT scans corresponding to a plurality of different polarization conditions to a sample; and
a processor configured to generate a mean image with a reduced birefringence-derived artifact by applying averaging to the plurality of images corresponding to the plurality of different polarization conditions.

10. A computer-readable non-transitory recording medium in which a program for processing an optical coherence tomography (OCT) image is recorded, wherein the program causes a computer to perform:
acquiring a plurality of images generated by applying a plurality of OCT scans corresponding to a plurality of different polarization conditions to a sample; and
generating a mean image with a reduced birefringence-derived artifact by applying averaging to the plurality of images corresponding to the plurality of different polarization conditions.
